(19) United States
(12) Patent Application Publication
(10) Pub. No.: US 2026/0233927 A1
(43) Pub. Date: Aug. 13, 2026

(54) RACK OF AUTOMATED WAREHOUSE

(71) Applicant: Murata Machinery, Ltd., Kyoto-shi, Kyoto (JP)

(72) Inventors: Mitsuru TAMAOKI, Kyoto-shi (JP); Mutsumi KASUGAI, Kyoto-shi (JP)

(21) Appl. No.: 19/154,097

(22) PCT Filed: Oct. 25, 2023
(86) PCT No.: PCT/JP2023/038558

§ 371 Date: Aug. 6, 2025

(30) Foreign Application Priority Data
Feb. 10, 2023 (JP) 2023-019078

(51) Int. Cl. B65G 1/04; A47B 55/00

(52) U.S. Cl. CPC B65G 1/04; A47B 55/00

(57) ABSTRACT

A rack of an automated warehouse includes a first horizontal beam, a second horizontal beam, and a shelf. The first horizontal beam includes a pair of beam holes penetrating through a rear side surface define projecting portions that project in directions facing each other. The second horizontal beam includes an engaged portion to be engaged by one end portion of the shelf and an insertion hole penetrating through a second upper surface in a thickness direction. The shelf includes a support surface, a first projecting piece, an insertion surface including an engaging hole into which the projecting portion is engaged when being inserted into the beam hole, a rear engaging portion, and a latch portion inserted into the insertion hole such that the second horizontal beam is engaged by the rear engaging portion.

### BACKGROUND OF THE INVENTION

### 1. Field of the Invention

The present invention relates to racks usable in automated warehouses or the like to hold cargo.

### 2. Description of the Related Art

The rack that is used in the automated warehouse or the like and holds the cargo is known. For example, Japanese Unexamined Patent Publication No. 2021-046271 discloses a rack of an automated warehouse including four pillars erected at four corners of a rectangle, two beams arranged parallel or substantially parallel to each other at front and rear of the four pillars in a left-right direction, and shelves bridged between the two beams. In the rack of an automated warehouse disclosed in Japanese Unexamined Patent Publication No. 2021-046271, one of the beams and one end of the shelf in a front-rear direction are engaged to fix each other. This facilitates construction as compared with fixing each other using a fastener such as a bolt.

### SUMMARY OF THE INVENTION

However, in the conventional rack of an automated warehouse described above, it is easy to fix one end of the shelf in the front-rear direction to one of the beams, but if the fastener such as the bolt is used to fix the other end of the shelf in the front-rear direction to the other of the beams, the effect is reduced by half. Further, when the shelf is engaged and fixed to both beams, it is necessary to be able to suppress movement in any of three axial directions perpendicular or substantially perpendicular to each other.

Therefore, example embodiments of the present invention provide racks of automated warehouses each being capable of suppressing movement of the shelf in any of three axial directions perpendicular or substantially perpendicular to each other with respect to the beam while including the engaging and fixing structure.

A rack of an automated warehouse according to an example embodiment of the present invention a body extending in a first direction to arrange a plurality of cargoes in the first direction and to transfer the plurality of cargoes from one side in a second direction perpendicular or substantially perpendicular to the first direction in a horizontal direction, wherein the body includes a first horizontal beam extending in the first direction, a second horizontal beam extending in the first direction, facing the first horizontal beam in the second direction, and located on an other side in the second direction with respect to the first horizontal beam, and a shelf extending between the first horizontal beam and the second horizontal beam to hold the cargo, wherein the first horizontal beam includes a first upper surface inclined downward from the one side toward the other side, a rear side surface extending downward from an end portion of the first upper surface on the other side and perpendicular or substantially perpendicular to the second direction, and a pair of beam holes penetrating in a thickness direction across the first upper surface and the rear side surface, the pair of beam holes penetrating through the rear side surface so as to provide projecting portions projecting in directions facing each other, the second horizontal beam includes an engaged portion to be engaged by one end portion of the shelf and an insertion hole penetrating through a second upper surface perpendicular or substantially perpendicular to a vertical direction in a thickness direction, and the shelf has a bent plate structure and includes a support surface to support the plurality of cargoes from below, a first projecting piece projecting to the one side from an end portion on the one side of the support surface and being in contact with the first upper surface of the first horizontal beam, a pair of insertion surfaces respectively insertable into the pair of beam holes in the first horizontal beam, the pair of insertion surfaces each including an engaging hole into which each of the projecting portions is engaged when the pair of insertion surfaces are respectively inserted into the pair of beam holes, a rear engaging portion engageable with the engaged portion of the second horizontal beam, and a latch portion inserted into the insertion hole in a state where the engaged portion of the second horizontal beam is engaged by the rear engaging portion.

In the rack of an automated warehouse having this configuration, the shelves are fixed to the first horizontal beam and the second horizontal beam by the following first fixing structure to fourth fixing structure. The first fixing structure is a structure in which the shelf is fixed to the first horizontal beam in the first direction by inserting (engaging) the insertion surface of the shelf into the beam hole of the first horizontal beam. The second fixing structure is a structure in which the shelf is fixed to the first horizontal beam in the second direction and the vertical direction (direction perpendicular or substantially perpendicular to both the first direction and the second direction) by engaging the engaging hole in the insertion surface to the projecting portion in the first horizontal beam. The third fixing structure is a structure in which the shelf is fixed to the second horizontal beam in the vertical direction by engaging the engaged portion of the second horizontal beam with the engaging portion of the shelf. The fourth fixing structure is a structure in which the shelf is fixed to the second horizontal beam in the first direction and the second direction by inserting (engaging) the latch portion on the shelf into the insertion hole in the second horizontal beam. In the rack of an automated warehouse according to an example embodiment of the present invention, since positioning actions by the four fixing structures of the first fixing structure to the fourth fixing structure are combined, movement of the shelf is suppressed in any of the first direction, the second direction, and the vertical direction with respect to both the beams of the first horizontal beam and the second horizontal beam. That is, the movement of the shelf can also be suppressed in any of the three axial directions perpendicular or substantially perpendicular to each other with respect to the beam without using the fastener such as the bolt, while including the engaging and fixing structure.

In a rack of an automated warehouse according to an example embodiment of the present invention, the first projecting piece may include a first surface inclined upward from an end portion the on one side of the support surface toward the one side, and a second surface inclined downward from an end portion on the one side of the first surface toward the one side, and the second surface may be in contact with the first upper surface of the first horizontal beam. With this configuration, it is possible to suppress jumping out of the cargo held by the shelf to the one side.

In the rack of an automated warehouse according to an example embodiment of the present invention, the second surface and the first upper surface may be in contact with each other such that an inclination direction of the second surface and an inclination direction of the first upper surface intersect each other. In other words, the second surface and the first upper surface do not come into contact with each other in a state where the inclination direction of the second surface and the inclination direction of the first upper surface are parallel or substantially parallel to each other. With this configuration, it is possible to effectively suppress the movement of the shelf in the second direction when the cargo is transferred.

In a rack of an automated warehouse according to an example embodiment of the present invention, the rear engaging portion may include a first engaging surface extending in the second direction, a second engaging surface extending downward in the vertical direction from an end portion on the other side of the first engaging surface, and a third engaging surface extending toward the one side in the second direction from an end portion on a lower side in the vertical direction of the second engaging surface, and the third engaging surface may be inclined downward from the other side toward the one side. With this configuration, it is easy to attach the shelf to the second horizontal beam while suppressing the movement of the shelf in the first direction using an elastic force of a flat plate formed of metal.

In a rack of an automated warehouse according to an example embodiment of the present invention, a plurality of the shelves may be arranged at intervals in the first direction, the plurality of shelves may include the support surfaces provided in a pair such that a first support surface and a second support surface face each other in the first direction, and a guide surface between the first support surface and the second support surface in the first direction, projecting upward from the first support surface and the second support surface, and extending in the second direction, and the guide surface including a bent plate structure between the first support surface and the second support surface in the first direction. The shelf having this configuration holds the cargo by supporting an end portion on one side of the cargo in the first direction from below by the first support surface of one of the shelves adjacent to each other, and supporting an end portion on the other side of the cargo in the first direction from below by the second support surface of the other of the shelves adjacent to each other. In addition, in the shelf having this configuration, it is possible to prevent the cargo from being displaced in the first direction by the guide surface.

In a rack of an automated warehouse according to an example embodiment of the present invention, the shelves each may include second projecting pieces projecting to one side and the other side in the first direction from an end portion of the guide surface on the other side in the second direction. With this configuration, it is possible to prevent the cargo from being displaced from the other side in the second direction.

According to example embodiments of the present invention, it is possible to suppress movement of a shelf in any of three axial directions perpendicular or substantially perpendicular to each other with respect to a beam while including the engaging and fixing structure.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view illustrating a portion of a rack used in an automated warehouse according to an example embodiment of the present invention.

FIG. 2 is a side view of a portion of a automated warehouse according to an example embodiment as viewed from an X direction.

FIG. 3 is a perspective view illustrating a shelf included in the rack of FIG. 1.

FIG. 4 is a sectional view of the rack in FIG. 1 as viewed from the X direction.

FIG. 5A is a perspective view of a connection portion between a first horizontal beam and the shelf as viewed obliquely from above. FIG. 5B is a perspective view of the connection portion between the first horizontal beam and the shelf as viewed obliquely from below.

FIG. 6 is a developed view in which a beam hole portion in the first horizontal beam is developed in plane.

FIG. 7 is a perspective view of a connection portion between a second horizontal beam and the shelf as viewed obliquely from above.

FIGS. 8A and 8B are views for explaining a procedure when the shelf is attached to the second horizontal beam.

FIGS. 9A and 9B are views for explaining a procedure when the shelf is attached to the first horizontal beam.

### DETAILED DESCRIPTION OF THE EXAMPLE EMBODIMENTS

Hereinafter, a rack 10 (rack of automated warehouse) according to an example embodiment will be described with reference to the drawings. In description of the drawings, the same elements are denoted by the same reference numerals, and redundant description will be omitted. In the present example embodiment, for convenience of description, an extending direction of the rack 10 is defined as an X direction (a first direction), a direction perpendicular or substantially perpendicular to the X direction on a horizontal plane is defined as a Y direction (a second direction), and a direction perpendicular or substantially perpendicular to both the X direction and the Y direction is defined as a Z direction (a vertical direction).

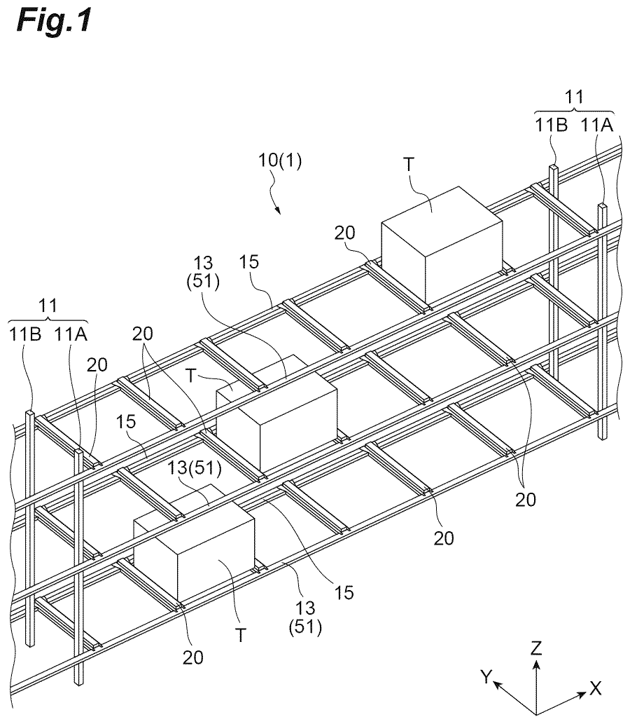

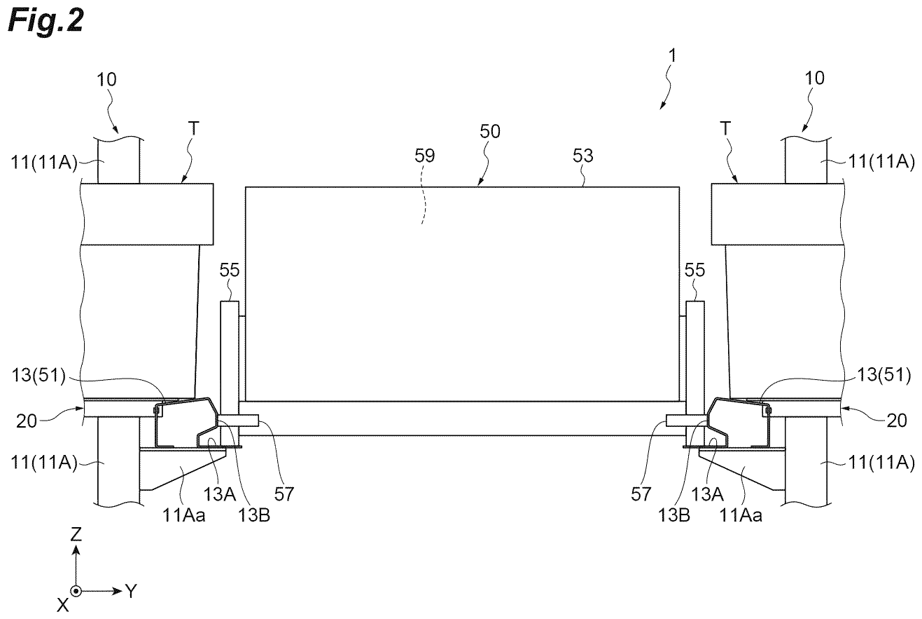

As illustrated in FIGS. 1 and 2, an automated warehouse 1 is a facility that can automatically carry a cargo T from an outside of the automated warehouse 1 into the rack 10 and automatically carry the cargo T held in the rack 10 to the outside of the automated warehouse 1 using a first conveyance device 50 capable of conveying the cargo T in a horizontal direction and a second conveyance device (not illustrated) capable of conveying the cargo T in the vertical direction.

The automated warehouse 1 includes a pair of racks 10 and 10, the first conveyance device 50, and the second conveyance device (not illustrated). Each of the pair of racks 10 and 10 can hold a plurality of the cargoes T arranged in the X direction which is one direction in the horizontal direction, and can hold a plurality of the cargoes T arranged in the Z direction which is the vertical direction. Hereinafter, an array in the Z direction may be referred to as a “stage”. Note that details of a configuration of the pair of racks 10 and 10 will be described later.

The first conveyance device 50 is disposed at each stage in the X direction between the pair of racks 10 and 10 arranged opposite to each other in the Y direction. The first conveyance device 50 is not particularly limited as long as it is a device capable of conveying the cargoes T held and transferring the cargoes T with the rack 10. The first conveyance device 50 of the present example embodiment includes a pair of rails 51 and 51 and a traveling carriage 53 that travels on the pair of rails 51 and 51.

The pair of rails 51 and 51 are arranged to face each other in the Y direction and extend in the X direction. Note that the pair of rails 51 and 51 include first horizontal beams 13 of the racks 10 and 10 described later in detail. The traveling carriage 53 includes a pair of traveling rollers 55 and 55 that roll on first guide surfaces 13A and 13A of a pair of first horizontal beams 13 and 13 (the pair of rails 51 and 51), a pair of side rollers 57 and 57 that roll on second guide surfaces 13B and 13B of the pair of first horizontal beams 13 and 13 (the pair of rails 51 and 51), and a transfer device 59 that transfers the cargo T from the traveling carriage 53 to the rack 10 and from the rack 10 to the traveling carriage 53 while sliding the cargo T. The pair of traveling rollers 55 and 55 are driven by a drive unit such as a motor (not illustrated). The transfer device 59 includes, for example, an arm portion (not illustrated) that can push out the cargo T to the rack 10 side or pull in the cargo T from the rack 10 side.

The second conveyance device is disposed in the Z direction at an end portion in the X direction of each of the pair of racks 10 and 10. The second conveyance device is not particularly limited as long as it is a device capable of conveying the cargo T held and transferring the cargo T between each stage of the rack 10 and a conveyance device (not illustrated) outside the automated warehouse 1. The second conveyance device is, for example, a vertical conveyor that conveys the cargo T in the Z direction.

The rack 10 includes pillars 11, first horizontal beams 13, second horizontal beams 15, and shelves 20.

The pillars 11 are columns erected on a floor surface, a foundation, or the like of a building in which the automated warehouse 1 is installed. The pillars 11 extend in the Z direction and are arranged in the X direction at predetermined intervals. The pillar 11 is configured to include first pillars 11A arranged on one side in the Y direction and second pillars 11B arranged on the other side in the Y direction.

The first horizontal beam 13 is a beam extending in the X direction along an arrangement direction of the first pillars 11A. A plurality of first horizontal beams 13 are arranged in the Z direction. The first horizontal beam 13 is provided corresponding to each stage described above. The first horizontal beam 13 is fixed to the first pillar 11A via a bracket 11Aa provided on the first pillar 11A.

The second horizontal beam 15 is a beam extending in the X direction along an arrangement direction of the second pillars 11B. The second horizontal beam 15 is disposed to face the first horizontal beam 13 in the Y direction. Further, a plurality of second horizontal beams 15 are arranged in the Z direction. The second horizontal beam 15 is provided corresponding to each stage described above. The second horizontal beam 15 is fixed to the second pillar 11B via a bracket (not illustrated) provided on the second pillar 11B.

Hereinafter, when a view of the rack 10 in which the second horizontal beam 15 appears to be farther back than the first horizontal beam 13 is defined as a front view, one side in the Y direction in the front view (that is, a side on which the first horizontal beam 13 is disposed) may be referred to as a front side, and the other side in the Y direction (that is, a side on which the second horizontal beam 15 is disposed) may be referred to as a rear side.

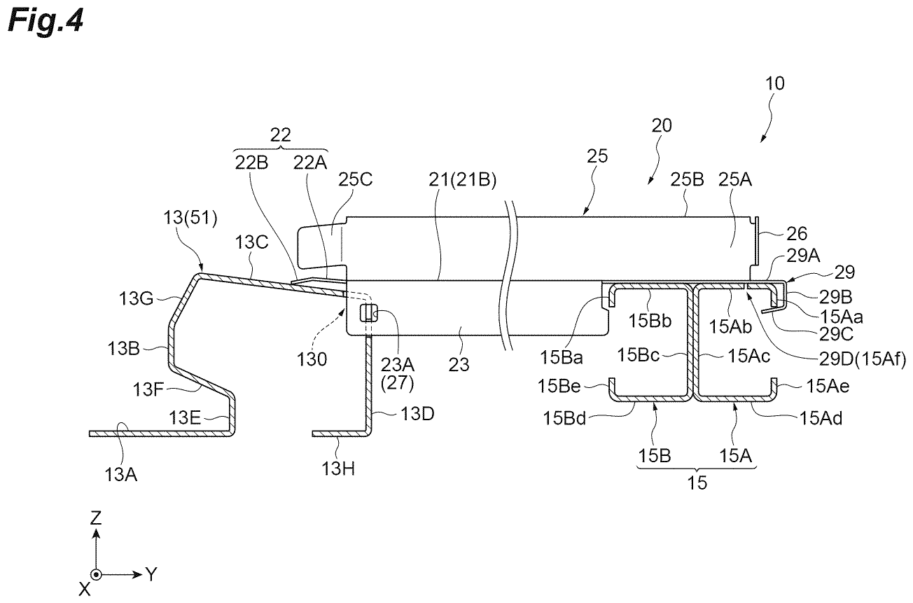

The first horizontal beam 13 will be described in more detail. As illustrated in FIGS. 2 to 4, the first horizontal beam 13 includes the first guide surface 13A, the second guide surface 13B, an upper surface (a first upper surface) 13C, a rear side surface 13D, a first connection surface 13E, a second connection surface 13F, a third connection surface 13G, and a lower surface 13H. In the first horizontal beam 13, a plate-shaped structure made of a material such as a steel material, an aluminum material, or a stainless steel material is bent by press working or the like to form each portion of the first guide surface 13A, the second guide surface 13B, the upper surface 13C, the rear side surface 13D, the first connection surface 13E, the second connection surface 13F, the third connection surface 13G, and the lower surface 13H.

As described above, the first horizontal beam 13 defines the pair of rails 51 and 51 of the first conveyance device 50 together with the first horizontal beam 13 of the rack 10 disposed to face each other in the Y direction. The first guide surface 13A defines a surface on which the traveling roller 55 of the first conveyance device 50 can roll. The first guide surface 13A is a surface perpendicular or substantially perpendicular to the Z direction and parallel or substantially parallel to the horizontal plane. The second guide surface 13B defines a surface on which the side roller 57 of the first conveyance device 50 can roll. The second guide surface 13B is a surface perpendicular or substantially perpendicular to the Y direction and is a surface parallel or substantially parallel to a vertical surface.

One end (A front end) of the shelf 20 in the Y direction is placed on the upper surface 13C. The upper surface 13C is inclined downward from the front side (one side) toward the rear side (the other side) in the Y direction. The rear side surface 13D is a surface extending downward from a rear end of the upper surface 13C and is a surface perpendicular or substantially perpendicular to the Y direction. The first connection surface 13E and the second connection surface 13F are surfaces connecting the first guide surface 13A and the second guide surface 13B. The third connection surface 13G is a surface connecting the second guide surface 13B and the upper surface 13C. In the first horizontal beam 13, a beam hole 130 extends from a portion of the upper surface 13C to a portion of the rear side surface 13D. The beam hole 130 is a portion into which an insertion surface 23 of the shelf 20 described later in detail is inserted. The beam hole 130 will be described in detail later.

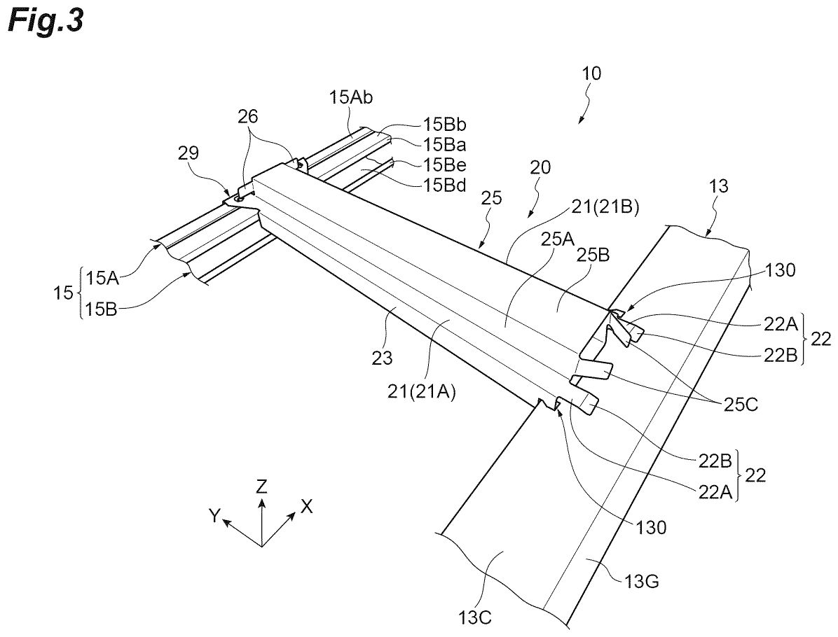

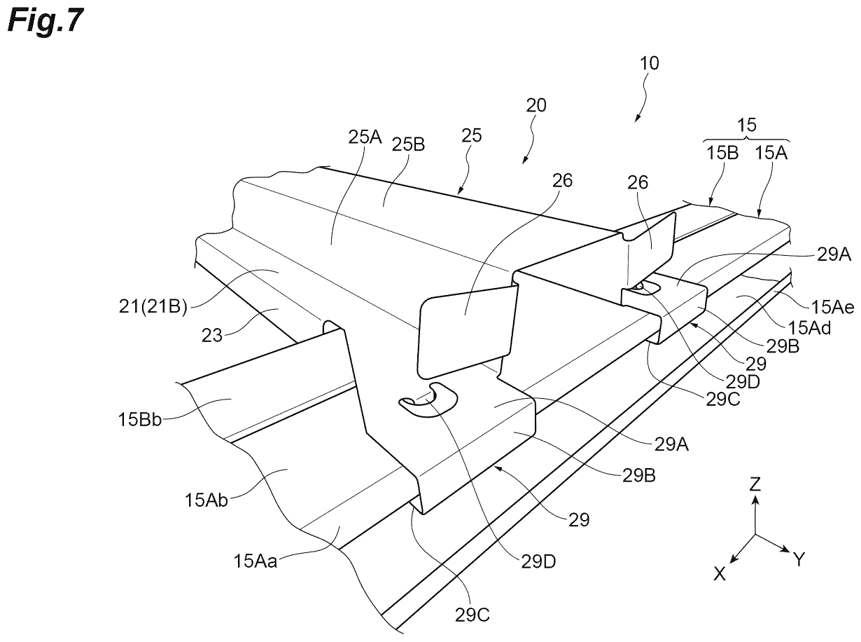

Next, the second horizontal beam 15 will be described in more detail. As illustrated in FIGS. 3 to 7, the second horizontal beam 15 includes a first lip channel steel 15A and a second lip channel steel 15B. The first lip channel steel 15A includes an upper lip (an engaged portion) 15Aa, an upper flange (an engaged portion/a second upper surface) 15Ab, a web 15Ac, a lower flange 15Ad, and a lower lip 15Ae. In the first lip channel steel 15A, a plate-shaped structure made of a material such as a steel material, an aluminum material, or a stainless steel material is bent by press working or the like to define each portion of the upper lip 15Aa, the upper flange 15Ab, the web 15Ac, the lower flange 15Ad, and the lower lip 15Ae.

The upper flange 15Ab is a portion to be an upper surface (the second upper surface) of the second horizontal beam 15. The upper flange 15Ab includes an insertion hole 15Af into which a latch portion 29D on the shelf 20 described later in detail can be inserted. The upper lip 15Aa is a portion hanging downward from a rear end of the upper flange 15Ab. The lower flange 15Ad is a portion to be a lower surface of the second horizontal beam 15. The web 15Ac is a portion connecting the upper flange 15Ab and the lower flange 15Ad and extending in the Z direction. The lower lip 15Ae is a portion erected upward from a rear end of the lower flange 15Ad.

The second lip channel steel 15B includes an upper lip 15Ba, an upper flange 15Bb, a web 15Bc, a lower flange 15Bd, and a lower lip 15Be. In the second lip channel steel 15B, a plate-shaped structure made of a material such as a steel material, an aluminum material, or a stainless steel material is bent by press working or the like to form each portion of the upper lip 15Ba, the upper flange 15Bb, the web 15Bc, the lower flange 15Bd, and the lower lip 15Be.

The upper flange 15Bb is a portion to be an upper surface of the second horizontal beam 15. The upper lip 15Ba is a portion hanging downward from a front end of the upper flange 15Bb. The lower flange 15Bd is a portion to be a lower surface of the second horizontal beam 15. The web 15Bc is a portion connecting the upper flange 15Bb and the lower flange 15Bd and extending in the Z direction. The lower lip 15Be is a portion erected upward from a front end of the lower flange 15Bd.

The first lip channel steel 15A and the second lip channel steel 15B are arranged in a back-to-back state (back-to-back) such that the web 15Ac and the web 15Bc are in contact with each other. The first lip channel steel 15A and the second lip channel steel 15B are connected to each other by bolts or rivets or welding, for example. The first lip channel steel 15A includes a portion to which a rear engaging portion 29 of the shelf 20 described later in detail is engaged.

The shelf 20 is configured to hold or support the cargo T. The shelf 20 is bridged between the first horizontal beam 13 and the second horizontal beam 15. The shelves 20 are arranged at predetermined intervals in the X direction. The cargo T is placed to straddle one shelf 20 and the other shelf 20 adjacent to each other in the X direction.

The shelf 20 includes a support surface 21, a first projecting piece 22, an insertion surface 23, a guide surface 25, a second projecting piece 26, and a rear engaging portion 29. In the shelf 20, a plate-shaped structure made of a material such as a steel material, an aluminum material, or a stainless steel material is bent by press working or the like to define each portion of the support surface 21, the first projecting piece 22, the insertion surface 23, the second projecting piece 26, the guide surface 25, and the rear engaging portion 29.

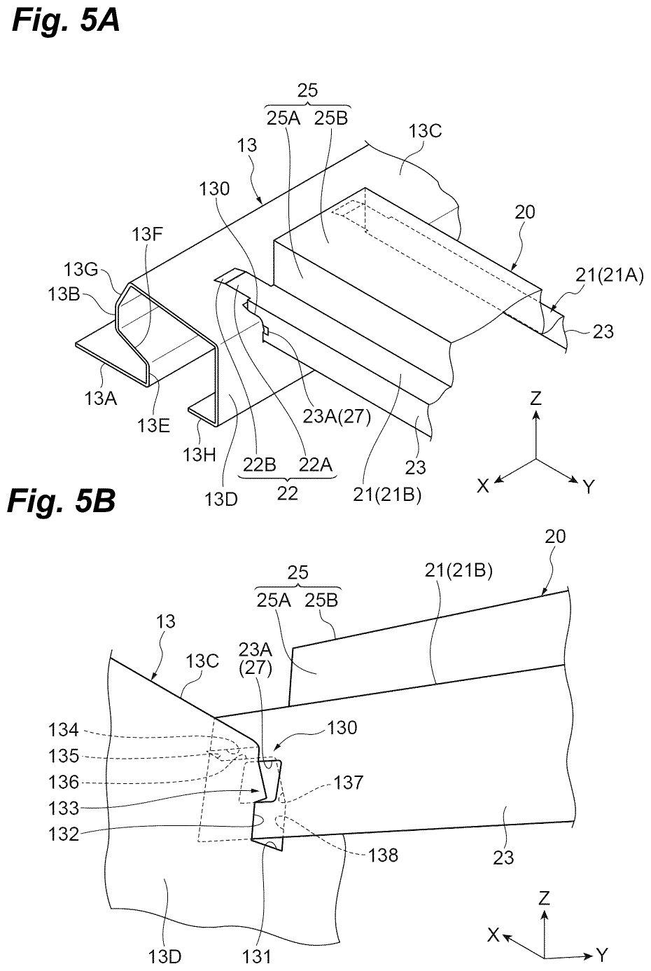

The support surface 21 is configured to support the cargo T from below. That is, the support surface 21 is a surface on which the cargo T is placed. The support surface 21 includes a first support surface 21A and a second support surface 21B defining a pair so as to sandwich the guide surface 25 in the X direction (see FIG. 5A). That is, the support surface 21 includes the first support surface 21A disposed on one side (left side) in the X direction of the guide surface 25 and the second support surface 21B disposed on the other side (right side) in the X direction of the guide surface 25. Each of the pair of support surfaces 21 and 21 (the first support surface 21A and the second support surface 21B) is a surface perpendicular or substantially perpendicular to the Z direction, and is a flat surface extending along the guide surface 25 extending in the Y direction.

The first projecting piece 22 is a portion projecting forward from a front end in the Y direction of the support surface 21. The first projecting piece 22 includes a first surface 22A inclined upward from a front end of the support surface 21 toward the front side, and a second surface 22B inclined downward from a front end of the first surface 22A toward the front side. An inclination direction of the second surface 22B and an inclination direction of the upper surface 13C are different from each other. That is, an extending direction of the second surface 22B in the Y direction and an extending direction of the upper surface 13C in the Y direction intersect each other and are not parallel or substantially parallel to each other.

The insertion surface 23 is a surface hanging downward from an end in the X direction of each of the pair of support surfaces 21 and 21, and is a surface perpendicular or substantially perpendicular to the X direction. Each of the pair of insertion surfaces 23 and 23 is inserted into the beam hole 130 of the first horizontal beam 13 described later in detail. Each of the pair of insertion surfaces 23 and 23 includes an engaging hole 23A into which a projecting portion 133 in the beam hole 130 is inserted in a state where the insertion surface 23 is inserted into the beam hole 130. The engaging hole 23A is a portion penetrating through the insertion surface 23 in a thickness direction of the insertion surface 23. The engaging hole 23A is disposed below a central portion of the insertion surface 23 in the Z direction. An opening shape of the engaging hole 23A is not particularly limited, and is, for example, a rectangular or substantially rectangular shape.

The pair of insertion surfaces 23 and 23 gradually spread to be separated from each other downward from each of the pair of support surfaces 21 and 21 in a state before the shelf 20 is attached to the first horizontal beam 13. When a force is applied to the pair of insertion surfaces 23 and 23 so as to bring the pair of insertion surfaces 23 and 23 close to each other, the pair of insertion surfaces 23 and 23 are deformed so that a distance between lower ends of the pair of insertion surfaces 23 and 23 decreases.

The guide surface 25 is configured to restrict movement of the cargo T placed on the shelf 20 in the X direction, and is also a portion to guide the cargo T in the Y direction while restricting the movement of the cargo T in the X direction when transferring the cargo T to the shelf 20. The guide surface 25 includes a pair of side surfaces 25A and 25A which are portions coming into contact with a portion of side surfaces of the cargo T, and an upper surface 25B connecting the pair of side surfaces 25A and 25A. Each of the pair of side surfaces 25A and 25A further includes a front guide surface 25C. The pair of front guide surfaces 25C and 25C guide the cargo T from the upper surface 13C of the first horizontal beam 13 to the support surface 21.

A pair of second projecting pieces 26 and 26 have surfaces perpendicular or substantially perpendicular to the Y direction, and project from rear ends of the guide surface 25 in the Y direction to both one side (right side) and the other side (left side) in the X direction. The pair of second projecting pieces 26 and 26 restricts the cargo T from jumping out to the rear side in the Y direction from the support surface 21.

The rear engaging portion 29 is configured to engage the shelf 20 to the second horizontal beam 15. When the first lip channel steel 15A (engaged portion) of the second horizontal beam 15 is engaged by the rear engaging portion 29, the shelf 20 is fixed in the vertical direction with respect to the second horizontal beam 15 (third fixing structure). The rear engaging portion 29 is at a rear end of the shelf 20 in the Y direction. The rear engaging portion 29 includes a first engaging surface 29A, a second engaging surface 29B, a third engaging surface 29C, and a latch portion 29D. The first engaging surface 29A is a portion parallel or substantially parallel to the upper flange 15Ab of the first lip channel steel 15A when the shelf 20 is attached to the second horizontal beam 15. The second engaging surface 29B is a portion parallel or substantially parallel to the upper lip 15Aa of the first lip channel steel 15A when the shelf 20 is attached to the second horizontal beam 15. The third engaging surface 29C is a portion extending forward from a lower end of the second engaging surface 29B. The third engaging surface 29C is inclined downward from the lower end of the second engaging surface 29B toward the front side. That is, the third engaging surface 29C is positioned such that a distance from first engaging surface 29A increases toward the front side.

The latch portion 29D is a portion projecting downward from the first engaging surface 29A, and is insertable into the insertion hole 15Af in the upper flange 15Ab of the first lip channel steel 15A in the second horizontal beam 15 when the shelf 20 is attached to the second horizontal beam 15. In a state where the latch portion 29D is inserted into the insertion hole 15Af, a rear portion of the shelf 20 is fixed in the X direction and the Y direction (fourth fixing structure).

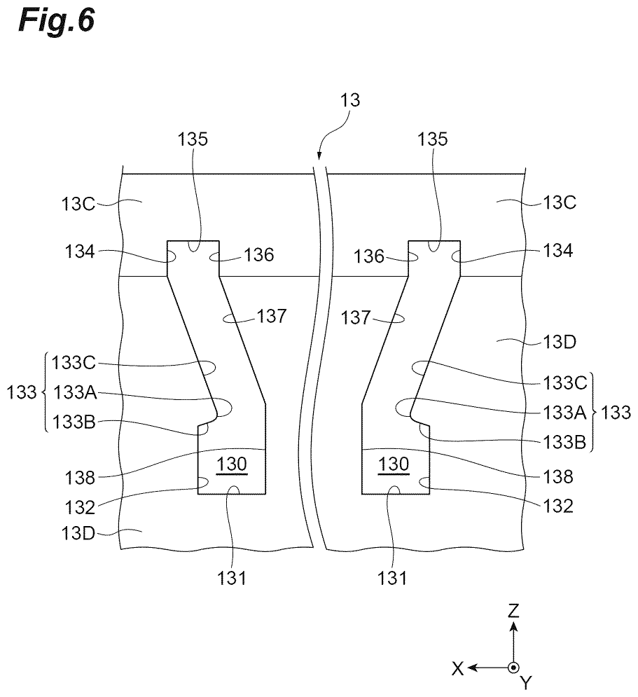

Next, a beam hole 130 in the first horizontal beam 13 and to connect the shelf 20 to the first horizontal beam 13 will be described. As illustrated in FIG. 6, beam holes 130 are arranged in a pair in the X direction. The pair of insertion surfaces 23 and 23 of the shelf 20 are respectively insertable into the pair of beam holes 130 and 130.

Each of the pair of beam holes 130 and 130 is a portion penetrating from the portion of the upper surface 13C to the portion of the rear side surface 13D in a thickness direction of the first horizontal beam 13. Each of the pair of beam holes 130 and 130 is opened upward from the portion of the upper surface 13C to the portion of the rear side surface 13D when the first horizontal beam 13 is viewed from above in the Z direction. Each of the pair of beam holes 130 and 130 (hereinafter, simply referred to as a beam hole 130) has a lower end portion 131, a first side edge portion 132, the projecting portion 133, a second side edge portion 134, an upper end portion 135, a third side edge portion 136, a fourth side edge portion 137, and a fifth side edge portion 138, which form an inner edge of the beam hole 130.

The lower end portion 131 is a portion on the rear side surface 13D and extending in the X direction at an inner edge lower end of the beam hole 130. The first side edge portion 132 is a portion on the rear side surface 13D and extending in the Z direction. The projecting portion 133 is a portion on the rear side surface 13D and projecting from the first side edge portion 132 toward an inside of the beam hole 130 at a position separated upward from the lower end portion 131. The most projecting portion 133A of the projecting portion 133 is disposed below a central portion of the beam hole 130 in the Z direction. The projecting portion 133 includes a lower end edge 133B rising toward the most projecting portion 133A and an upper end edge 133C falling toward the most projecting portion 133A.

The second side edge portion 134 is a portion on the upper surface 13C and extending in the Y direction at an inner edge upper end of the beam hole 130. The upper end portion 135 is a portion on the upper surface 13C and extending in the X direction at the inner edge upper end of the beam hole 130. The third side edge portion 136 is a portion on the upper surface 13C and extending in the Y direction at the inner edge upper end of the beam hole 130. The third side edge portion 136 faces the second side edge portion 134 in the X direction. The fourth side edge portion 137 is a portion on the rear side surface 13D and facing the upper end edge 133C in the X direction. The fifth side edge portion 138 is a portion on the rear side surface 13D and extending in the Z direction. The fifth side edge portion 138 connects the fourth side edge portion 137 and the lower end portion 131.

The pair of beam holes 130 and 130 are arranged such that the projecting portions 133 respectively included therein project inward from the first side edge portions 132 arranged on the outer side. In other words, the pair of beam holes 130 and 130 are arranged to be line-symmetric with each other.

Next, a state in which the insertion surface 23 of the shelf 20 is inserted into the beam hole 130, that is, a state in which the front end (a front engaging portion 27) of the shelf 20 is engaged to the first horizontal beam 13 will be described. In a state where the insertion surface 23 is inserted into the beam hole 130, the shelf 20 is fixed to the first horizontal beam 13 in the X direction (first fixing structure). Further, in a state where the insertion surface 23 is inserted into the beam hole 130, the engaging hole 23A is in a state where the projecting portion 133 is inserted, the engaging hole 23A and the projecting portion 133 are engaged, and the shelf 20 is fixed to the first horizontal beam 13 in the Y direction and the Z direction (second fixing structure). Further, the lower end portion 131 of the beam hole 130 and a lower end edge 23C of the insertion surface 23 are in contact with each other. Thus, a position of the shelf 20 with respect to the first horizontal beam 13 is determined in the Z direction, and the shelf 20 is stably held by the first horizontal beam 13. Further, a lower end of the engaging hole 23A and the lower end edge 133B of the projecting portion 133 are in contact with each other. Thus, two upper and lower points are determined, and movement of the insertion surface 23 in the Z direction is suppressed.

A portion of the insertion surface 23 above the engaging hole 23A is in contact with the third side edge portion 136 located on an opposite side of the first side edge portion 132 in the beam hole 130. Furthermore, a portion of the insertion surface 23 below the engaging hole 23A is in contact with the first side edge portion 132 below the projecting portion 133. £ In one insertion surface 23, since both surfaces in the X direction are in contact with the inner edge of the beam hole 130, movement of the insertion surface 23 in the X direction is suppressed. More specifically, a distance between the first side edge portion 132 and the third side edge portion 136 in the X direction matches a thickness of the insertion surface 23 of the shelf 20, and an outer surface of the insertion surface 23 below the engaging hole 23A is in close contact with the first side edge portion 132 extending in the vertical direction, and an inner surface of the insertion surface 23 above the engaging hole 23A is in close contact with the third side edge portion 136. The same applies to the insertion surface 23 disposed on the opposite side in the X direction. Thus, movement of the shelf 20 with respect to the first horizontal beam 13 in the X direction is suppressed.

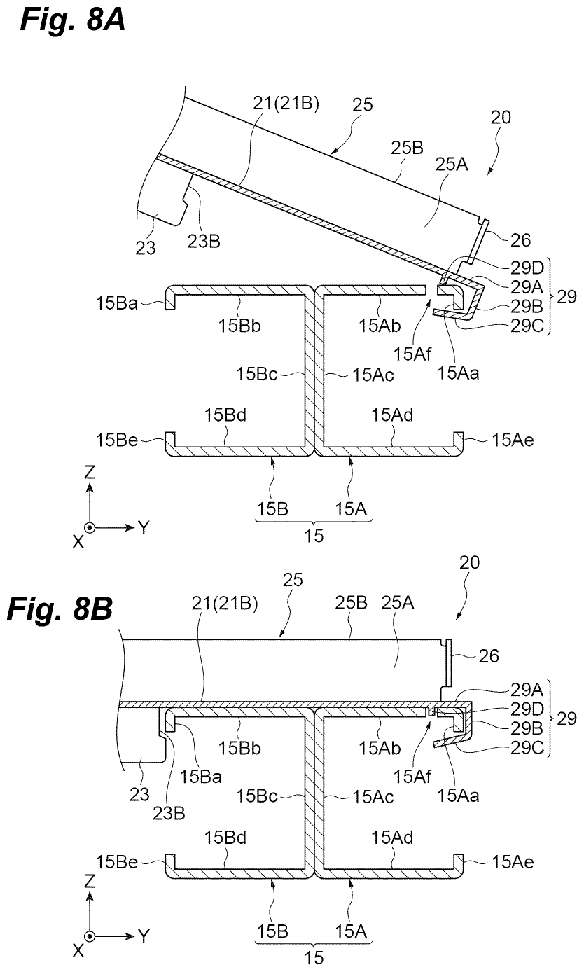

Next, a procedure for attaching the shelf 20 to the first horizontal beam 13 and the second horizontal beam 15 will be described. First, a procedure for attaching a rear end portion of the shelf 20 to the second horizontal beam 15 will be described. As illustrated in FIG. 8A, the rear engaging portion 29 formed at the rear end of the shelf 20 is hooked on the second horizontal beam 15. More specifically, the shelf 20 is inclined such that the rear end of the shelf 20 faces downward, and the third engaging surface 29C of the rear engaging portion 29 is moved below the lower lip 15Ae of the first lip channel steel 15A.

Subsequently, while the shelf 20 is pulled toward the front side in the Y direction in a state where the rear engaging portion 29 is hooked on the second horizontal beam 15, the shelf 20 is laid down so as to be in a horizontal state. At this time, by inclining the shelf 20 to the horizontal state while bringing a rear end portion 23B of the insertion surface 23 into contact with the upper lip 15Ba of the second lip channel steel 15B, the shelf 20 can be roughly positioned with respect to the second horizontal beam 15 in the Y direction.

Then, as illustrated in FIG. 8B, when the shelf 20 is inclined horizontally, the latch portion 29D of the rear engaging portion 29 is inserted into the insertion hole 15Af in the upper flange 15Ab of the first lip channel steel 15A in the second horizontal beam 15. Thus, the rear end (rear engaging portion 29) of the shelf 20 is positioned in the Z direction by the first engaging surface 29A, the second engaging surface 29B, the third engaging surface 29C, and the first lip channel steel 15A, and is positioned in the X direction and the Y direction by the latch portion 29D and the insertion hole 15Af.

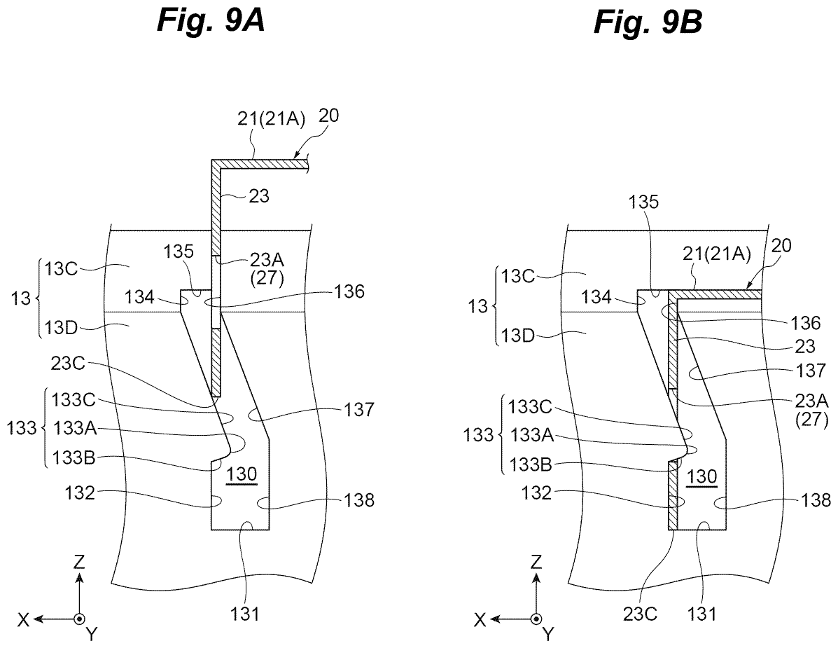

Subsequently, a procedure for attaching a front end portion of the shelf 20 to the first horizontal beam 13 will be described. As described above, when the shelf 20 is laid down in the horizontal state, a front end portion of the insertion surface 23 of the shelf 20 is inserted into the beam hole 130 in the first horizontal beam 13 as illustrated in FIG. 9A. In this state, by applying a downward force to the front end portion of the shelf 20, the lower end edge 23C of the insertion surface 23 comes into contact with the upper end edge 133C of the projecting portion 133 in the beam hole 130. Then, when the insertion surfaces 23 and 23 are guided downward by the downward force, the insertion surfaces 23 deform in a direction (inward) of the pair of insertion surfaces 23 and 23 in the X direction.

Furthermore, when the downward force is applied to the front end of the shelf 20, a lower end edge of the engaging hole 23A of the insertion surface 23 goes beyond the most projecting portion 133A of the projecting portion 133 and comes into contact with the first side edge portion 132. At this time, a portion of the projecting portion 133 is inserted into the engaging hole 23A of the insertion surface 23, resulting in a state illustrated in FIG. 9B. Note that the movement of the insertion surface 23 described above is similar in the other of the pair of insertion surfaces 23. Thus, the front end (front engaging portion 27) of the shelf 20 is positioned in the X direction by the first side edge portion 132 of the beam hole 130 and the insertion surface 23, and is positioned in the Y direction and the Z direction by the projecting portion 133 of the beam hole 130 and the engaging hole 23A of the insertion surface 23. Now, the shelf 20 can be attached to the first horizontal beam 13 and the second horizontal beam 15.

Note that a procedure of detaching the shelf 20 from the first horizontal beam 13 and the second horizontal beam 15 is performed by a procedure reverse to the above attachment procedure. First, by applying a force in a direction (inner side) in which the pair of insertion surfaces 23 and 23 of the shelf 20 approach each other, the projecting portion 133 is removed from a state of being inserted into the engaging hole 23A, and the front end of the shelf 20 is lifted upward. Thus, engaging between the front end (front engaging portion 27) of the shelf 20 and the first horizontal beam 13 is released. Subsequently, the shelf 20 is moved backward in a state where the shelf 20 is inclined such that the rear end of the shelf 20 faces downward. Thus, engaging between the rear end (rear engaging portion 29) of the shelf 20 and the second horizontal beam 15 is released. Now, the shelf 20 can be detached from the first horizontal beam 13 and the second horizontal beam 15.

Functions and effects of rack 10 according to the above example embodiment will be described. In the rack 10 of the above example embodiment, the shelves 20 are fixed to the first horizontal beam 13 and the second horizontal beam 15 by the first fixing structure to the fourth fixing structure described above. Note that the first fixing structure is a structure in which the shelf 20 is fixed to the first horizontal beam 13 in the X direction by inserting (engaging) the insertion surface 23 of the shelf 20 into the beam hole 130 of the first horizontal beam 13. The second fixing structure is a structure in which the shelf 20 is fixed to the first horizontal beam 13 in the Y direction and the Z direction by engaging the beam hole 130 in the insertion surface 23 to the projecting portion 133 in the first horizontal beam 13. The third fixing structure is a structure in which the shelf 20 is fixed to the second horizontal beam 15 in the Z direction by engaging the engaged portion which is a portion of the first lip channel steel 15A in the second horizontal beam 15 with the rear engaging portion 29 of the shelf 20. The fourth fixing structure is a structure in which the shelf 20 is fixed to the second horizontal beam 15 in the Y direction and the X direction by inserting (engaging) the latch portion 29D on the shelf 20 into the insertion hole 15Af in the second horizontal beam 15.

In the rack 10 of the above example embodiment, since the positioning actions by the above-described four fixing structures are combined, the movement of the shelf 20 is suppressed in any of the X direction, the Y direction, and the Z direction with respect to both the beams of the first horizontal beam 13 and the second horizontal beam 15. That is, the movement of the shelf 20 can also be suppressed in any of the three axial directions perpendicular or substantially perpendicular to each other with respect to the first horizontal beam 13 and the second horizontal beam 15 without using a fastener such as a bolt, while including the engaging and fixing structure.

In the rack 10 of the above example embodiment, the first projecting piece 22 includes the first surface 22A inclined upward from an end portion on one side of the support surface 21 toward the one side, and the second surface 22B inclined downward from an end portion on the one side of the first surface 22A toward the one side, and the second surface 22B is in contact with the upper surface 13C of the first horizontal beam 13. Thus, it is possible to suppress displacement of the cargo T held by the shelf 20 to the front side.

In the rack 10 of the above example embodiment, the second surface 22B and the upper surface 13C are in contact with each other such that the inclination direction of the second surface 22B and the inclination direction of the upper surface 13C intersect each other. In other words, in the above example embodiment, the second surface 22B and the upper surface 13C do not come into contact with each other in a state where the inclination direction of the second surface 22B and the inclination direction of the upper surface 13C are parallel or substantially parallel to each other. Thus, it is possible to effectively suppress the movement of the shelf 20 to the front side in the Y direction when the cargo T is transferred.

In rack 10 of the above example embodiment, the third engaging surface 29C of the rear engaging portion 29 is inclined downward from the rear side toward the front side. This makes it easy to attach the shelf 20 to the second horizontal beam 15 while suppressing the movement of the shelf 20 in the Z direction using the elastic force of the flat plate formed of metal.

The plurality of shelves 20 of the rack 10 of the above example embodiment are arranged at intervals in the X direction, and the shelf 20 includes the support surface 21 in which the first support surface 21A and the second support surface 21B are provided in a pair in the X direction, and the guide surface between the first support surface 21A and the second support surface 21B in the X direction, projecting upward from the first support surface 21A and the second support surface 21B, and extending in the Y direction. The shelf 20 of the present example embodiment holds the cargo T by supporting a right end of the cargo T in the X direction from below by the first support surface 21A of one of the shelves 20 adjacent to each other, and supporting a left end of the cargo T in the X direction from below by the second support surface 21B of the other of the shelves 20 adjacent to each other. In addition, in the shelf 20 of the present example embodiment, it is possible to prevent the cargo T from being displaced in the X direction by the guide surface 25.

In the rack 10 of the above example embodiment, the shelf 20 includes the second projecting pieces 26 projecting in both directions in the X direction from the rear end of the guide surface 25 in the Y direction. This makes it possible to prevent the cargo T from jumping out from the rear side in the Y direction.

Although example embodiments have been described above, the present invention is not limited to the above example embodiments. Various modifications can be made without departing from the gist of the present invention.

The conveyance device that is disposed in the automated warehouse 1 and transports the cargo T may be any type of device, and for example, may include a transport device such as a stacker crane provided to be able to travel in the X direction and to be able to move in the Z direction.

In the above example embodiments and the above modifications, an example in which the first horizontal beam 13 also serves as the rails 51 of the traveling carriage 53 has been described, but the first horizontal beam 13 and the rails 51 may be provided separately. In this case, the rails 51 are provided along the first horizontal beam 13 on the front side of the first horizontal beam 13 in the Y direction. In addition, in a case where the conveyance device such as the stacker crane is provided as described above, the rails 51 are provided on the floor surface or the like on which the rack 10 is installed.

In the above example embodiments the above modifications, the second horizontal beam in which two pieces of lip channel steel are arranged has been described as an example, however, the second horizontal beam may be made of one piece of lip channel steel or may be made of groove steel or the like having different sectional shapes.

The shelf 20 of the above example embodiments and the above modifications has been described by taking an example in which the guide surface 25 is included, but the shelf 20 may be only of the flat support surface 21 without the guide surface 25 being formed. In this case, by forming a size of the support surface 21 so that one or a plurality of cargoes T can be placed, one or a plurality of cargoes T can be held in one shelf 20.

An example in which the first projecting piece 22 of the shelf 20 of the above example embodiments and the above modifications is bent to project at a central portion in the Y direction has been described, but the first projecting piece 22 may have a linear shape without being bent.

The third engaging surface 29C of the rear engaging portion 29 of the shelf 20 of the above example embodiments and the above modifications has been described by taking an example in which the third engaging surface 29C is inclined downward from the rear side toward the front side in the Y direction, but may extend in the horizontal direction from the rear side toward the front side. That is, the first engaging surface 29A, the second engaging surface 29B, and the third engaging surface 29C may be U-shaped or substantially U-shaped when viewed from the X direction.

While example embodiments of the present invention have been described above, it is to be understood that variations and modifications will be apparent to those skilled in the art without departing from the scope and spirit of the present invention. The scope of the present invention, therefore, is to be determined solely by the following claims.

1-6. (canceled)

7. A rack of an automated warehouse comprising:
a body extending in a first direction to arrange a plurality of cargoes in the first direction and to transfer the plurality of cargoes from one side in a second direction perpendicular or substantially perpendicular to the first direction in a horizontal direction; wherein
the body includes:
a first horizontal beam extending in the first direction;
a second horizontal beam extending in the first direction, facing the first horizontal beam in the second direction, and located on an other side in the second direction with respect to the first horizontal beam; and
a shelf extending between the first horizontal beam and the second horizontal beam to hold the cargo; wherein
the first horizontal beam includes a first upper surface inclined downward from the one side toward the other side, a rear side surface extending downward from an end portion of the first upper surface on the other side and perpendicular or substantially perpendicular to the second direction, and a pair of beam holes penetrating in a thickness direction across the first upper surface and the rear side surface, the pair of beam holes penetrating through the rear side surface so as to provide projecting portions projecting in directions facing each other;
the second horizontal beam includes an engaged portion to be engaged by one end portion of the shelf and an insertion hole penetrating through a second upper surface perpendicular or substantially perpendicular to a vertical direction in a thickness direction; and
the shelf has a bent plate structure and includes:
a support surface to support the plurality of cargoes from below;
a first projecting piece projecting to the one side from an end portion on the one side of the support surface and being in contact with the first upper surface of the first horizontal beam;
a pair of insertion surfaces respectively insertable into the pair of beam holes in the first horizontal beam, the pair of insertion surfaces each including an engaging hole into which each of the projecting portions is engaged when the pair of insertion surfaces are respectively inserted into the pair of beam holes;
a rear engaging portion engageable with the engaged portion of the second horizontal beam; and
a latch portion inserted into the insertion hole in a state where the engaged portion of the second horizontal beam is engaged by the rear engaging portion.

8. The rack of an automated warehouse according to claim 7, wherein
the first projecting piece includes a first surface inclined upward from an end portion on the one side of the support surface toward the one side, and a second surface inclined downward from an end portion on the one side of the first surface toward the one side; and
the second surface is in contact with the first upper surface of the first horizontal beam.

9. The rack of an automated warehouse according to claim 8, wherein the second surface and the first upper surface are in contact with each other such that an inclination direction of the second surface and an inclination direction of the first upper surface intersect each other.

10. The rack of an automated warehouse according to claim 7, wherein
the rear engaging portion includes a first engaging surface extending in the second direction, a second engaging surface extending downward in the vertical direction from an end portion on the other side of the first engaging surface, and a third engaging surface extending toward the one side in the second direction from an end portion on a lower side in the vertical direction of the second engaging surface; and
the third engaging surface is inclined downward from the other side toward the one side.

11. The rack of an automated warehouse according to claim 7, wherein
the shelf includes a plurality of shelves at intervals in the first direction;
the plurality of shelves each include the support surface provided in a pair such that a first support surface and a second support surface face each other in the first direction, and a guide surface between the first support surface and the second support surface in the first direction, projecting upward from the first support surface and the second support surface, and extending in the second direction; and
the guide surface includes a bent plate between the first support surface and the second support surface in the first direction.

12. The rack of an automated warehouse according to claim 11, wherein the plurality of shelves each include second projecting pieces projecting to one side and the other side in the first direction from an end portion of the guide surface on the other side in the second direction.
